(19) United States
(12) Patent Application Publication
(10) Pub. No.: US 2013/0340058 A1
(43) Pub. Date: Dec. 19, 2013

(54) SECURE SYSTEM AND METHOD FOR COLLECTING, AUTHENTICATING, AND USING PERSONAL DATA

(71) Applicants: Robert B. Barnes, Scottsdale, AZ (US); Robert William Littlefield, Scottsdale, AZ (US)

(72) Inventors: Robert B. Barnes, Scottsdale, AZ (US); Robert William Littlefield, Scottsdale, AZ (US)

(21) Appl. No.: 13/914,942

(22) Filed: Jun. 11, 2013

Related U.S. Application Data
(60) Provisional application No. 61/659,237, filed on Jun. 13, 2012.

(51) Int. Cl. G06F 21/32

(52) U.S. Cl. CPC G06F 21/32
USPC 726/6

(57) ABSTRACT

A system for collecting, storing, authenticating, and managing personal information, such as identity data, skill data, qualification data, certification data, for individuals and/or organizations. The system surely collects identity, skill, qualification, and certification data and enables the generation of a personal identification credential that can be used to securely authenticate the identity of an individual and, thereafter, retrieve skill, qualification, certification data, and/or other personal information for the individual. The system also enables an individual with an issued personal identification credential via third party verification to securely update personal information, such as skills, qualifications, and certifications data for storage in a secure cloud database system.

### RELATED APPLICATIONS

This application claims priority under 35 U.S.C. §119(e) to provisional patent application No. 61/659,237 titled “Secure System To Collect, Authenticate, And Use Personal Data Stored On A Cloud Database” filed on Jun. 13, 2012 and which is hereby incorporated by reference herein.

### FEDERALLY SPONSORED RESEARCH OR DEVELOPMENT

Not Applicable.

### COMPACT DISK APPENDIX

Not Applicable.

### BACKGROUND

Individuals and organizations increasingly use computers and other electronic devices to gain access to information and services via available public networks, such as the Internet or World Wide Web (the “Web”). Many organizations, including corporations, educational institutions, and government agencies now have private networks of computers that provide their user's access to the organization's intranet and/or to the Web. Such organizations may also authorize remote access to data maintained on their intranets via the Internet and Web. For example, an organization may establish a Web presence for public or private use, or some combination thereof.

As the growth of information and services available on the Web continues, the means for accessing the Web and/or intranets is also growing. Accordingly, there is a steady migration of Web functionality to an increasing range of wired and wireless computers and electronic devices, such as Web enabled televisions, cell phones, pagers, personal digital assistants (PDAs) and so forth. Each of these devices may be configured to send and/or receive information made available by an organization via the Internet and Web.

Cloud computing is a style of computing in which dynamically scalable resources and/or services are provided over the Web. Cloud computing essentially entrusts remote services with storage and or processing of an end user's data. As a result, cloud computing may accelerate application performance, help enable companies to quickly deliver business results, achieve greater productivity, realize a faster time to market, and result in increased customer satisfaction. By providing the ability to store, share, and analyze large amounts of data, cloud computing thereby helps to ensure that people have access to information at the right time which, in turn, can improve decision-making, employee productivity, and collaboration.

### BRIEF SUMMARY

The present invention provides a method for securely collecting and storing in a cloud database personal data such as name, address, employer, training, licenses, authorizations, experience, and other activities or information relating to a skill and/or occupation. Such data will be authenticated as to its accuracy. These data will remain the personal property of the individual but will be accessible by others with the individual's authorization.

In accordance with one embodiment of the present invention, there is provided a method for personal identification ensuring that when data is collected, authenticated, or used, the individual's identity can be positively verified through the use of eye-readable and/or machine-readable biometric identification features securely contained in or on a personal identification credential.

According to another embodiment of the present invention, data can be collected through direct input from a computer workstation and/or mobile computing device. It can be collected directly from a stand-alone training device such as a simulator. It can also be collected directly from other databases, such as a training management system, operational schedule, governmental database, or commercial personal data system.

In yet another embodiment of the present invention, a system is provided such that data can be authenticated by an authorized person and/or through an electronic link to official records such as for a birth certificate, passport, license, or other applicable document.

In a final embodiment of the present invention, a method is provided such that data can be selectively formatted and authorized by the individual for distribution as an electronic file. The present invention will be best understood by reference to the following detailed description when read in conjunction with the accompanying drawings.

### BRIEF DESCRIPTION OF THE DRAWINGS

FIG. 1A is a block diagram of a computing system that includes a secure data collection and storage system.

FIG. 1B depicts an exemplary embodiment of a client computing device according to one aspect of the secure data collection and storage system.

FIG. 1C depicts an exemplary embodiment of a data storage system according to an aspect of the secure data collection and storage system.

FIG. 2 depicts the components of an exemplary a personal identification credential.

FIG. 3 is a block diagram illustrating communications between components of a secure data collection and storage system.

FIG. 4A is a block diagram of a computing device configured with a secure data collection and storage application according to one aspect of the secure data collection and storage system.

FIG. 4B is a screen shot of an exemplary data input form according to one aspect of the secure data collection and storage system.

FIGS. 5-6 are process flows depicting methods for requesting a credentials and modifying stored personal data according to aspects of the secure data collection and storage system.

### DETAILED DESCRIPTION

The detailed description set forth below in connection with the appended drawings is intended as a description of an exemplary embodiment of the invention, and is not intended to represent the only form in which the present invention may be constructed or utilized. The description sets forth the functions and the sequence of steps for developing and/or operating a secure data collection and storage system. It is to be understood, however, that the same or equivalent functions and sequences may be accomplished by different embodiments that are also intended to be encompassed. It is further understood that the use of relational terms such as first and second, and the like are used solely to distinguish one from another entity without necessarily requiring or implying any actual relationship or order between such entities.

According to one aspect, the secure data collection and storage system uses a personal identification credential (credential) and a secure cloud data management system to securely collect and store personal data or information relating to a skill and/or occupation of an individual. Such data will be authenticated as to its accuracy. These data will remain the personal property of the individual but will be accessible by others with the individual's authorization.

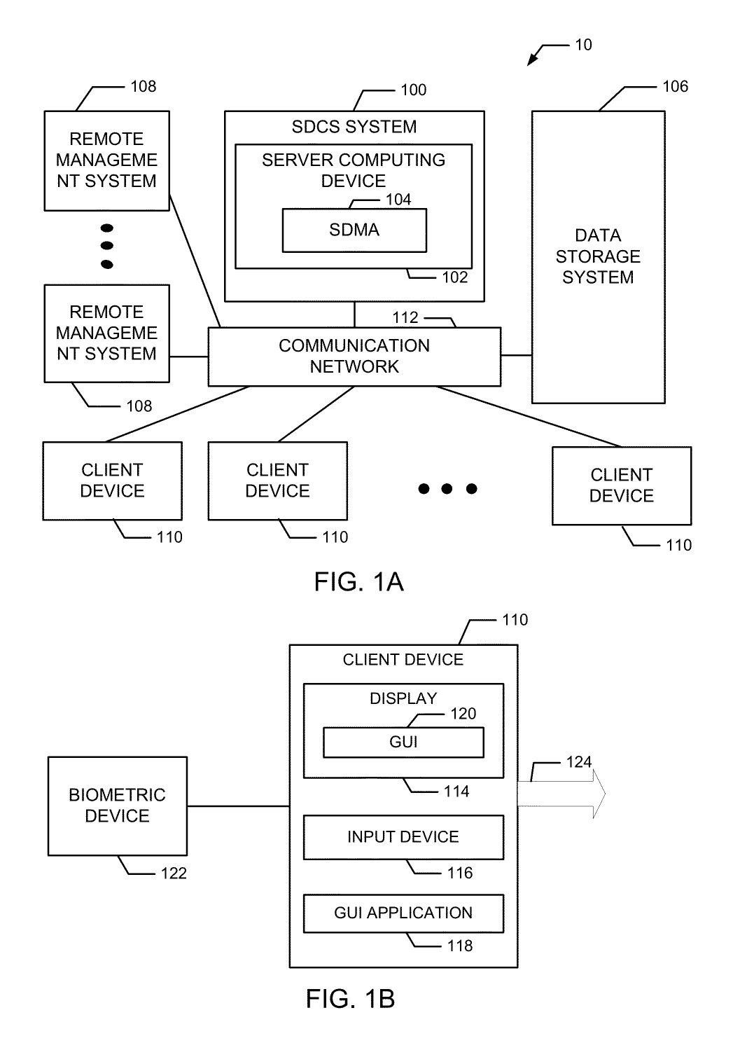

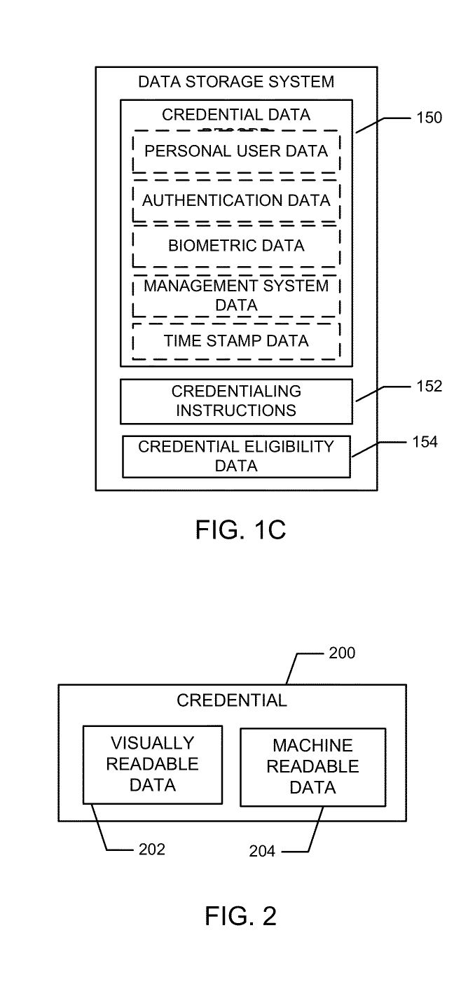

FIG. 1A is a block diagram of an exemplary computing environment 10 that includes a secure data collection and storage (SDCS) system 100 according to one aspect of the invention. The SDCS system 100 includes at least one server computing device 102 that includes a secure data management application (SDMA) 104. The server computing device 102 is communicatively connected and/or linked to a data storage system 106, one or more remote management system 108, and one or more client computing devices (client devices) 110.

The server computing device (sever device) 102 is a computer or computing device that includes one or more processors and memory and executes the SDMA 104 to manage the collection of, storage of, and access to personal data and to manage the generation of credentials. The server device 102 is configured to securely receive data from and/or transmit data to the one or more client devices 110 through the communication network 112. The server device 102 is also configured to securely receive data from and/or transmit data to data to one or more the remote management system 108 through the communication network (network) 112.

According to one aspect, the SDMA 104 generates the credential in response to a credential request for a particular requestor received from the client device 110 or the remote management system 108. For purposes of illustration, the particular requestor is described herein as the user of the client device 110. However, it is contemplated that a particular requestor may be a party other than the user of the client device 110.

The credential is a generated document in electronic and/or physical form that provides a positive verification of the user's identity. The credential can provide verification through visual (i.e. eye-readable) data that requires no intervening device between the human eye and the data visually depicted on the credential. The visually depicted data, may include, for example the user's photograph, signature, and selected personal data. The credential can also provide verification via machine readable data incorporated in the credential. According, to one aspect, the security of data and integrity of the credential are provided by special printing and the physical construction of the credential.

The data storage system 106 is configured to receive personal data from one or more remote management system 108 over the network 112. The data storage system 106 includes, for example, at least one processor and volatile and/or non-volatile memory. In one example, the network 112 is the Internet, an intranet, or another communication network. Other conventional and/or later developed wired and wireless networks may also be used. Although the data storage system 106 is shown as being located remotely from the server computing device 102 and connected via the network 112, it is contemplated that the data storage system 106 can be located on or integrated within the server computing device 102 in other aspects of the SDCS 100. According to one aspect, the server computing device 102 and the data storage system 106 are in a cloud computing configuration.

Each remote management system 108 is, for example, a computing or processing device, such as a standard personal computer, a laptop computer, smart phones, tablet computers, stand-alone training device (e.g., flight simulator), or another processing device. Each remote management system 108 allows an administrator or an authorized user to register for the credential service provided by the SDCS system 100 on behalf of a particular user by submitting that particular user's personal data. According to one aspect, each remote management system 108 corresponds to a participating entity that provides particular training data, experience, or authentication of such data related to a skill, profession, and/or qualification for one or more users. For example, one entity may provide authentication of a license or certificate claimed by the user; another entity may provide a record of training accomplished; while still another entity may provide a record of relevant experience; and another entity may provide information relevant to the user's legal or medical status.

According to other aspects, each remote management system 108 may receive updated personal data from a third party, such as an educational institution, a training institution, a governmental agency, etc. For example, an authorized instructor or administrator of a flight training program for airline pilots may submit data regarding a particular pilot's certification or non-certification directly to the remote management system 108.

According to other aspects, each remote management system 108 is configured to receive credentialing generating instructions from the SDCS system 100 for a successfully registered user. The remote management system 108 then generates a credential in accordance with the received instructions for that particular user.

According to one aspect, a particular user applies for a credential by interacting with a registration form at the client device 110 received from the remote management system 108. Thereafter, as explained in more detail below, the particular user interacts with a client computing device 110 to input the registration/personal data, such as described above, into the registration form displayed on a display associated with the computing device 102. After receiving the personal data from the client device 110, a credential generation request (credential request) is generated at the remote management system 108 and transmitted to the server computing device 102.

In this example, the server computing device 102, the data storage system 106, the remote management system 108, and the client computing devices 110 communicate using a secure data transfer protocol, such as the Secure Sockets Layer (SSL) protocol. In other aspects, the network 112 over which the SDCS system 100, data storage system 106, and the remote management systems 108 may communicate include, by way of example, a Hypertext Transfer Protocol Secure (“HTTPS”) communication protocol, a Mobile Communications (GSM) network, a code division multiple access (CDMA) network, 3rd Generation Partnership Project (3GPP), an Internet Protocol (IP) network, a Wireless Application Protocol (WAP) network, a WiFi network, or an IEEE 802.11 standards network, as well as various combinations thereof.

According to another aspect, the registration/personal data may be collected via a telecommunication device (not shown). For example, a requesting user (i.e., requestor) desiring to receive a credential from the SDCS system 100 may provide the registration/personal data to an administrator or authorized user of the remote management system 108 during a telephone and/or during an in-person conversation.

In other aspects, it is contemplated that the client 100 generates the credential request (e.g., credential request 124) and submits the request directly to the server computing device 102 via the communication network 112. For example, after the particular user interacts with a client computing device 110 to input the registration/personal data, such as described above, into the registration form, a credential request is generated and submitted to the server computing device 102 via the communication network 112.

The client device 110 includes one or more processors and volatile and/or non-volatile memory and is configured to receive data and/or communications from, and/or transmit data and/or communications to the server device 102 via the communication network 112. Examples of a client computing device 110 include smart phones, tablet computers, desktop computers, simulators, dedicated training devices, and other computing devices. The client 108 communicates via wireless and/or wireline communication. The SDCS system 100 can not only securely accept data from a variety of client computing devices 110, including smart phones, tablet computers, desktop computers, simulators and dedicated training devices, the system 100 can also securely accept data in a variety of formats, including direct manual input and the ability to import data directly from existing remote management systems 108, such as training management systems, operational scheduling systems, governmental databases, and commercial data systems.

FIG. 1B is a block diagram that depicts exemplary components of the client device 110. The client device 110 includes a display 114, such as a computer monitor, for displaying data and/or graphical user interfaces. The client device 110 may also include an input device 116, such as a keyboard or a pointing device (e.g., a mouse, trackball, pen, or touch screen) to enter data into or interact with graphical user interfaces. Each client device 110 may also include a graphical user interface (or GUI) application 118, such as a browser application, to generate a graphical user interface 120 on the display 114. The graphical user interface 120 enables a user of the client device 110 to interact with various data entry forms to submit personal data, such as credentialing data, for the purpose of requesting a personal identification certificate. Such personal registration data may include but not be limited to the user's name, title, organization, address, birth date, physical description, etc. In addition, digital biometric data describing the user is collected by other electronic devices, such as a biometric device 122 that is connected to or communicatively linked to the client device 110. Such data may include but not be limited to the user's photograph, signature, and fingerprint. After entering the personal data, the credential generation request (e.g., credential request 124) is generated.

It is also contemplated that in aspects where personal data is collected or submitted through a remote management system 108, the remote management system may include one or more biometric devices. According to one aspect, the SDCS automatically imports enrollment data (personal data and basic biometrics) from that remote management system 108.

FIG. 1C depicts an exemplary embodiment of a data storage system 106 according to one aspect of the SDCS 100. According to one aspect, the data storage system 106 stores a credential data record 150, credential instruction data 152, and credential eligibility data (eligibility data) 154.

Each credential data record 150 includes the personal data and at least one desired credential type for each user registered with the SDCS system 100. As described above, personal data may include personal data, such as full legal name; legal physical address (including county and country); mailing address (if different); driver's license number; professional license or registration numbers, skills, educational degrees, social security number; telephone number(s), etc. The desired credential is, for example, a particular credential that a particular user would like to obtain. The credential may be associated with a particular user's profession and provide evidence or verification of that particular user's identity and a particular skill within a profession and/or authorization to participate in particular activity.

Each credential data record 150 may also include authentication data including biometric data. As described in more detail below, the authentication data and/or biometric data may be used for authenticating registered user and/or third party users.

Each credential data record 150 includes management system data that identifies a local training management system that can generate a desired credential for the user. As described above, the local management system is, for example, a particular remote management system 108 that can submit credential generation request on behalf of a user and/or generate a credential for a particular user in accordance with received instructions.

Each credential data record 150 includes time stamp data. According to one aspect, the time stamp data indicates a time the personal data was stored and modified.

Credential instruction data 152 includes instructions for generating various types of credentials. The credential may be issued, for example, in a horizontal ID card format and/or in vertical hanging badge format. The vertical hanging badge format is generally used for access control purposes. Either format can include additional access control features that provide for automated identification of the bearer and visually indicate a level of professional authority.

The eligibility data 154 defines for example the minimum or threshold requirements for receiving one or more credentials. For example, the eligibility data may specify the minimum educational requirement, minimum amount of actual experience, minimum training time, required certifications, etc. for each of various credentials.

Referring now to FIG. 2, a block diagram depicts exemplary components of a generated credential 200. As described above, the credential 200 includes both visually readable data 202 and machine-readable data 204. Visually readable data 202 includes visual data types such as logos, global and/or nationally recognized codes, photographs (e.g., passport), finger print, signature, and other personal data. The machine-readable data 204 provide a positive digital identification interface with other components of the system. Such machine readable data can be contained in, but not be limited to, various types of integrated circuit chips, radio frequency identification (RFID) chip data, optical character recognition codes, bar codes, and other analog or digital interface devices. Various levels of security are provided by the functional data methodology used.

The credential 200 can also be used as an access control device using its basic functionality (eye-readable and/or machine-readable) or additional functionality as may be required. The credential 200 can be used for visual access control by a third party by comparing the visual data (such as a photograph) on the card with the user. It can be used for electronic access control by interfacing with an access control system through one or more of the credential's analog or digital interface devices. According to one aspect, credential 200 is a national ID compliant security credential this is, for example, compliant with ICAO MRTD 9303d standards, which defines the specifications for machine-readable passports, visas and ID cards (“travel documents”) used in crossing borders.

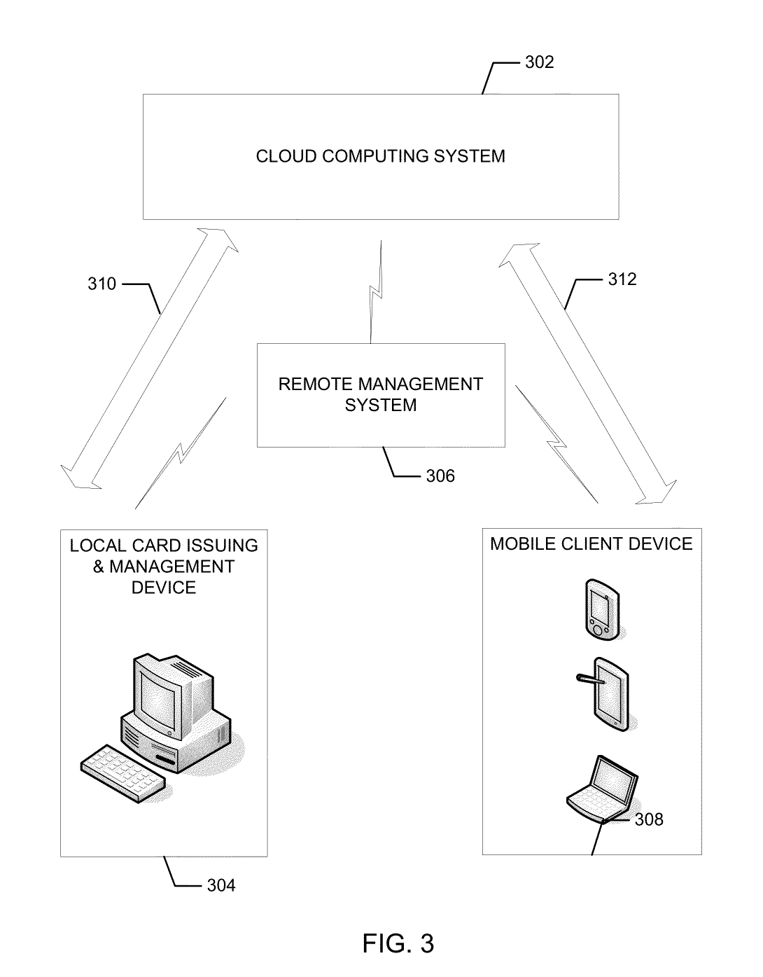

Referring now to FIG. 3, a block diagram illustrates communications between a cloud computing system 302 (e.g., server computing device 102 and/or data storage system 106), a local card issuing and management system 304, a remote management system 306, and a mobile client device 308 (e.g., client computing device 110). According to one aspect, the cloud computing system 302 is configured to receive credentialing data from one or more local card issuing and manage system 304 over a secure network. Accordingly, the local card issuing and manage systems 304 is provided secure access, as indicated by 310, to personal data stored on the cloud computing system 302. As discussed above, the SDCS system 100 may use the Secure Sockets Layer (SSL) and Transport Layer Security (TLS) protocols for both the authentication of data provided to the cloud computing system 302 and the data being extracted or reported from the cloud computing system 302. Although the remote management system 306 and the local card issuing and management system 304 are shown as being separate, it is contemplated that the remote management 306 and card issuing and management system may be integrated in other aspects.

According to another aspect, the cloud computing system 302 is configured to receive credentialing data from the mobile client device 308 over a communication network that may or may not be a secure network. In this aspect, the mobile client device 308 is provided limited access, as indicated by 312, to personal data stored on the cloud computing system 302. For example, the mobile client device 308 is configured with an app (e.g., SDMA 104) that enables the device owner to download or upload specific data from/to the cloud computing system 302. The device owner uses his/her credential to register the device and authenticate his or her limited authority to view or input certain data. Stated differently, personal data cannot be downloaded or uploaded without authorization by the individual that owns the data.

In addition to storing and reporting data, the SDCS system 100 also analyzes and correlates data to produce insights such as the productivity of different training modalities and potential safety issues. As an example, the SDCS system 100 analyzes data received from remote management systems 106 to see how students using different training modalities compare in terms of how quickly they achieve their training goals, how much training they require to achieve various milestones, and how successful they are after completing their training. In this example, users of the SDCS system 100 can then draw conclusions regarding the relative effectiveness of different training modalities.

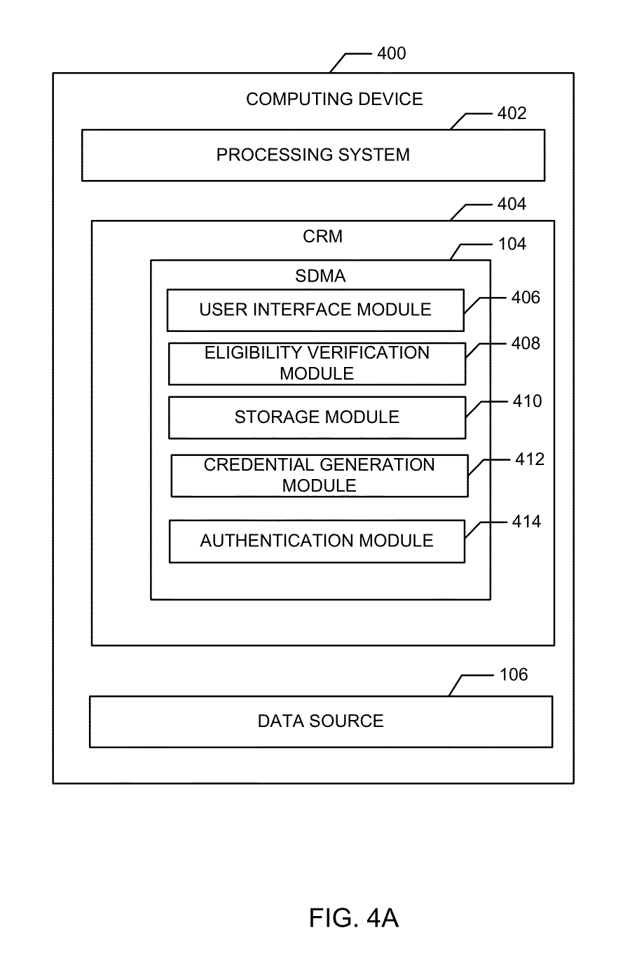

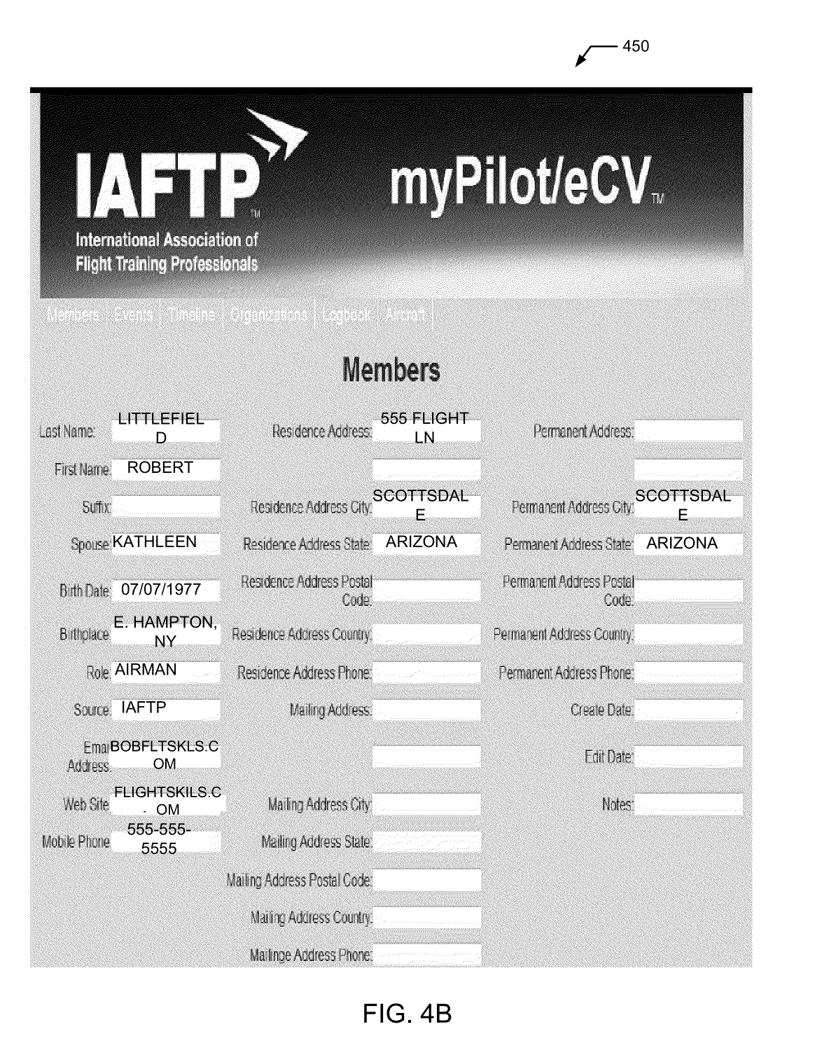

FIG. 4A is a block diagram depicting an exemplary SDMA 104 executing on a computing device 400 (e.g., server computing device 102). According to one aspect, the computing device 400 includes a processing system 402 that includes one or more processors or other processing devices. The processing system 402 executes the SDMA 104 to securely collect and store personal data and/or generate a credential based on such personal data.

According to one aspect, the computing device 400 includes a computer readable medium (“CRM”) 404 configured with the SDMA 104. The SDMA 104 includes instructions or modules that are executable by the processing system 402 to securely collect and store the personal data and/or to generate a credential.

The CRM 404 may include volatile media, nonvolatile media, removable media, non-removable media, and/or another available medium that can be accessed by the computing device 400. By way of example and not limitation, the CRM 404 comprises computer storage media and communication media. Computer storage media includes nontransient memory, volatile media, nonvolatile media, removable media, and/or non-removable media implemented in a method or technology for storage of information, such as computer readable instructions, data structures, program modules, or other data. Communication media may embody computer readable instructions, data structures, program modules, or other data and include an information delivery media or system.

A user-interface (UI) module 406 generates one or more input forms for display at the remote management system 108 and/or client device 110 in response to a data entry or registration request received from the remote management system 108 and/or client device 110. For example, a user (e.g., an administrative user) of the remote management system 108 uses an input device to interact with, for example, a web browser via a user interface to access and display a registration form provided by the SDMA 104. In one example, the user interface includes a display, such as a computer monitor, for viewing data and/or forms and an input device, such as a keyboard or a pointing device (e.g., mouse, trackball, pen, touch pad, or other device), for allowing the administrator to interact with the registration form to generate a credential generation request. For example, an administrator user enters personal data into the registration form on behalf of a requestor that desires to obtain a credential. After data entry is completed, the administrative user uses the UI to select for example a submit control displayed on the registration from to generate the credential request 124.

According to another aspect, the UI module 406 generates the registration form for display via the display 114 of the client computing device 110 in response to a data entry request received from the client device 110. After data entry is completed, the user of the client device 110 selects, for example, a submit control displayed on the registration form to generate the credential request 124.

FIG. 4B depicts an exemplary registration form 450 that enables the users or members to enter registration data to register with the SDCS 100. The registration forms 450 is, for example, an HTML document, such as a web page that includes various input fields for each receiving different types of personal data, such as user biographical data, skill data, experience data. After the user enters personal data and selects registration control, a credential generation request is generated. The credential generation request, whether generated by the remote management system 108 or client device 110 includes user personal data, such as full legal name; legal physical address (including county and country); mailing address (if different); driver's license number; professional license or registration numbers, skills, educational degrees, social security number; telephone number(s) by which the individual can be contacted. Additional descriptive, biographic, demographic, and other personal information may also be collected. The registration form 450 depicted in FIG. 4B is meant to be non-limiting. Other examples of registration forms exist.

According to one aspect, the registration form 450 may also include a data entry field that enables the user to identify a desired credential for issuance. For example, the registration form may include a selection control, such as a list box or a drop down list that identifies a list of credential types or professions that SDCS system can provide credentials. For example, the selection control may identify Pilots as one of the listed professions that a user can select.

According to one aspect, the registration form may also comprise data entry fields for authentication data, such as a personal identification number (PIN or User ID) and a password and instruction for submitting biometric data. According to one aspect, the user enters their user id and/or password via the registration form and enters biometric data via one or more biometric input devices that are a communicatively connected to and/or integrated with the client device 110. According to one aspect, the biometric input device is, for example, a finger print scanner and/or camera. Other types of biometric input device exist.

Referring back to FIG. 4A, an eligibility verification module 408 verifies that a requestor has submitted sufficient data to successfully register for the SDCS system 100 in response to the received credential generation request. For example, if the one or more required fields of the registration form lack the appropriate data format and/or content (e.g., blank social security number field or failure to submit biometric data), the eligibility verification module 408 transmits an incomplete registration notification to the user. The incomplete registration notification notifies the user that the supplied registration information is incomplete and the user is instructed to supply or correct such personal data.

The eligibility verification module 408 also verifies that the requestor of a credential is eligible for the desired credential by comparing personal data included in the credential request 124 to the credential eligibility data retrieved from the data storage system 106. For example, the eligibility verification module 408 may compare qualification data included in the credential generation request 124 to threshold qualification data as defined by the credential eligibility data to determine eligibility. If the qualification data included in the credential generation request 124 does not satisfy or match the threshold qualification data, the eligibility verification module 408 transmits an ineligible notification to the user. The ineligible notification notifies the user that that the requestor is ineligible for the credential.

The eligibility verification module 408 also verifies that the received credential generating request 124 was verified or witnessed by a second authorized person. For example, According to one aspect, the eligibility verification module 408 verifies that a particular credential generating request 124 received from a mobile device corresponds to an approved or recognized mobile device. For example, a credential generating request 124 received from a mobile phone may include device identification information, such as an assigned telephone number. In this example, the verification module 408 compares the device identification information included in the request to approved device identification data stored in the data storage system 106. The approved device identification data is stored in the data storage system 106, for example, during a registration process of a particular user.

That is, no data can be uploaded to the cloud database from a mobile device without eligibility verification module 408 verifying that the device is recognized by the system, the supervisor being authenticated with his/her credential, and the individual being authenticated with his/her credential. In this way, all data added to an individual's personal record will be verified by (1) an authorized third party and (2) the device used.

It is also contemplated that in aspects where personal data is collected and/or submitted through a remote management system 108, the remote management system 108 may include a local application (not shown) with one or more executable modules. According to one aspect, the remote management system 108 executes a local eligibility verification module (not shown) to perform similar operations such as described above in connection with the eligibility verification module 408. As one example, the remote management system 108 executes the local eligibility verification module to verify that a credential generating request 124 received from a client device 110 was verified or witnessed by a second authorized person.

A storage module 410 generates and stores a credential data record (e.g., credential record 150) for each successfully registered user in the data storage system 106. As explained above, each credential data record includes personal data, authentication data, biometric data, and a desired credential, time stamp data.

According to another aspect, storage module 410 records time stamps for each credential record being stored and/or modified in the data storage system 106. The time stamp may corresponds to date and time personal data was entered at a source device (e.g., remote management system 108 or client device 110) or the date and time the credential record was on stored or modified on the data storage system 106.

A credential generation module 412 transmits credential generation instructions to the local, regional, or global card issuing location (e.g., remote management system 108) for each generated credential data record 150. For example, after a particular credential data record is generated, the credential generation module 408 identifies a particular user, the desired credential, and a local training/management system identified by the data included in that particular credential data record 150. The credential generation module 412 queries the data management system 106 to identify credentialing instructions that correspond to the desired credential. The credential generation module 412 then transmits the credentialing instructions to the identified local training management system and the local training management system generates a credential in accordance with the instructions. Thereafter, the particular user can obtain the credential from the local training management system.

After a particular user has successfully registered and a corresponding credential data record has been generated, as described above, the credential can be used for visual access control by a third party and/or can be used for electronic access control by interfacing with an access control system through one or more of the credential's analog or digital interface devices.

In addition, after a particular user has successfully registered and a corresponding credential data record has been generated, that particular user can be authenticated when later requesting access to the SDCS system 100 by supplying their corresponding user ID and a password and/or the generated credential. For example, if a registered user desires to view, make additions, changes, or deletions to his or her personal data stored in the data management system 106, that user must first provide authentication data.

For example, according to another aspect, the UI module 406 generates another input form for display at the remote management system 108 and/or client device 110 in response to a data modification request received from the remote management system 108 and/or client device 110, respectively. Thereafter, a user (e.g., an administrative user) of the remote management system 108 or user of the client device 110 uses a corresponding input device to interact with, for example, a web browser via a user interface to access and display a data modification form provided by the secure data management application 104 and/or stored personal data.

The administrative user of the remote management system 108 or user of the client device 110 interacts with the data modification form to identify a particular credential data record 150 to modify and to enter modified personal data into one or input fields. After data entry is completed, the user of the client computer selects, for example, an update control displayed on the data modification form to generate the modification request.

According to another aspect, an authentication module 414 authenticates the modification request prior to making changes, modifications or deletions to personal data in the data management system 106. For example, the authentication module 414 compares authentication data received from the administrator via the administrative computing device to authorization data stored in the identified credential data record 150 the data management system 106. As described above, the stored authentication data may include a password, a user ID, and/or biometric data previously provided during registration.

According to another aspect, the authentication request is generated automatically when the user swipes, scans, or otherwise interfaces with a previously generated credential.

If user authentication data received from the administrative computing device 110 does not match authentication data stored in the data store 102, the user is not authenticated and denied access to the credential data record 150. If the user authentication data received from the computing device 110 matches the authentication data stored in the credential data record 150, the administrative user or user is authenticated and allowed to store and manipulate the personal data 104 stored in the credential data record 150.

According to another aspect, a user modification request that is received directly from the client device 110 and not via a third party authentication system (e.g., remote managements system 106) may be flagged or labeled by the storage modules as “not authenticated” even if the user has supplied correct authentication data. Authentication by a third party is accomplished, for example, by that party's identity being electronically verified with the third party's personal identification credential at the same time as the user. For example, the third party may manually input his/her own corresponding credential authentication data or scan their credential via a credential reading device.

According to yet another aspect, no data can be uploaded to the data management system 106 based on a modification request received from a mobile device without that device being recognized by the system, the supervisor being authenticated with his/her credential, and the individual being authenticated with his/her credential. In this way, all data added to an individual's personal record will be verified by (1) an authorized third party and (2) the device used.

According to one aspect, after a particular user is authenticated, the UI module 406 generates a menu for display that indicates particular task that the user is eligible to perform and or information that user is eligible to view without additional or third party authentication. For example, the UI module 406 can generate for display specific experience (such as most recent upgrade or refresher training) and authorizations (such as licenses, medical clearances, permits, etc.) depending on the device owner's authority to view.

According to another aspect, when the user modification request is received at the remote management system 108 from the client device 110, the data included therein is authenticated during input. For example, the remote management system 108 executes a local authentication module (not shown) to perform similar operations such as described above in connection with the e authentication module 414. Thereafter, modified personal data, such as personal training milestone data, will be automatically uploaded to the SDCS system 100.

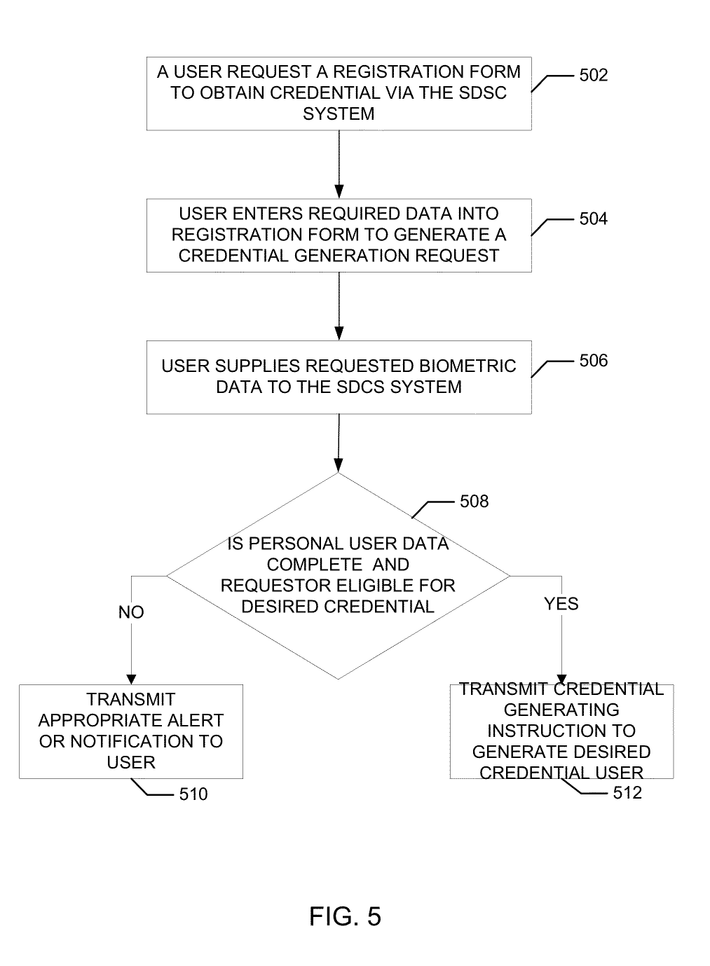

FIG. 5 illustrates a method for collecting and storing personal data for generating a personal identification credential. At 502, a user uses a client device 110 to request and/or view put form, such as a registration form, to obtain a personal identification credential via the SDCS system 100. The user may use the client device to request the personal identification credential directly from the SDCS system 100 or may request the personal identification credential indirectly from the SDCS system 100 via a remote management system 108. The user enters required personal data and a desired credential type into the input form to generate a credential generation request for direct or indirect submission to the SDCS system 100 at 504. At 506, the user provides other authentication data, such as biometric data, for direct or indirect submission to the SDCS system 100. The SDCS system 100 receives the credential generation request and verifies that the personal data included in the request is complete and/or that the requestor is eligible to receive the desired credential to at 508.

If the SDCS system 100 determines that registration data is incomplete or the requestor is not eligible for the desired credential at 508, an appropriate alert or notification (e.g., incomplete registration notification or ineligible notification) is transmitted to the user at 510. If the SDCS system 100 determines that registration data is complete at 508 and that the requestor is eligible, the appropriate credential generating instructions are transmitted to the local remote management system to generate the desired personal identification credential at 512.

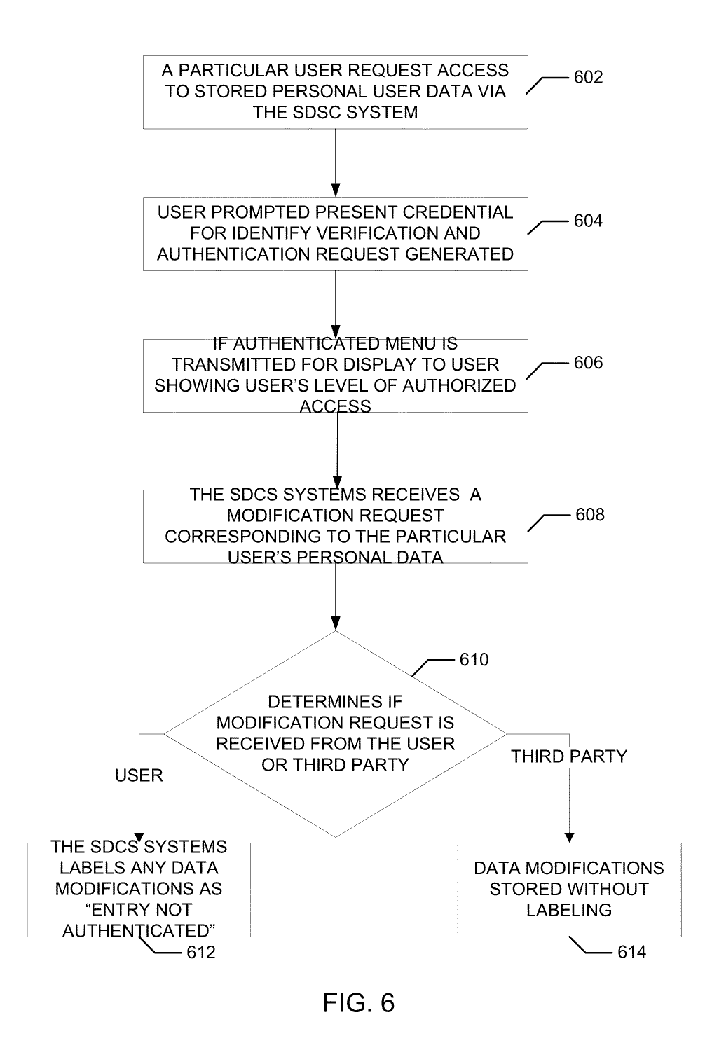

FIG. 6 illustrates a method for accessing, updating, or modifying personal data stored in the data management system. At 602, a user may use the client device 110 to submit an access request to access their corresponding personal data stored in the data storage system 106. The user may use the client device 110 to communicate directly with the SDCS system 100 to submit the access request. Optionally, the user may use the client device 110 to submit the access request indirectly to the SDCS system 100 via the remote management system 108. Thereafter user will be prompted to present their credential for identity verification and generate an authentication request at 604. For example, the user can swipe or scan the personal credential via a credential reading device (not shown), such as a bar code reader or OCR code reader that is configured to read machine-readable data 204 to generate the authentication request. As another example, the user can input a credential number to generate the authentication request.

After the user identity is confirmed, the SDCS system 100 generates a menu for display at the client device at 606. According to one aspect, the menu identifies the user's level of access for the desired task. Stated differently, the menu will indicate what action the identified user is authorized to take with respect to that user's credential data record 150. At 608, SDCS system 100 receives a modification request for a particular user's personal data. The SDCS system 100 determines whether the modification request is received from a user or from an administrative user (or third party) at 610. If the modification request is received directly from the user (e.g., without authentication by a third party) any resulting data modification will be labeled as “entry not authenticated” in the data storage system at 612. If the modification request is received from the user via a third party (e.g., authenticated) any resulting data modification are stored without labeling at 614.

The description above includes example systems, methods, techniques, instruction sequences, and/or computer program products that embody techniques of the present disclosure. However, it is understood that the described disclosure may be practiced without these specific details. In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology.

What is claimed is:

1. A method for generating a credential, the method comprising:
receiving a credential generation request at at least one processing system, the credentialing request comprising personal data and biometric data corresponding to a particular requestor and identifying a desired credential type;
comparing the personal data to credential eligibility data to verify that the particular requester is eligible for the desired credential type;
storing the personal data and biometric data in a credential record of a secure data storage system for a verified eligible requestor;
retrieving credential generating instructions from the secure data storage system that correspond to the desired credential type; and
transmitting the credential generating instructions to a remote computing device for the verified eligible requestor, wherein the remote computing device is configured to generate a personal identification credential for the verified eligible requestor in accordance with the credential generating instructions.

2. The method of claim 1 wherein the personal identification credential comprises:
visually readable data comprising at least one of a logo, a globally recognized code, a photograph, personal data, and a signature; and
machine-readable data comprising at least one of a radio frequency identification (RFID) chip data, an optical character recognition code, and a bar code.

3. The method of claim 1 wherein biometric data includes a finger print, a signature, a photograph.

4. The method of claim 1 wherein the remote computing device remote device comprises at least one of a personal computer, a laptop computer, and a stand-alone training device.

5. The method of claim 1 further comprising transmitting an ineligibility notification to the remote computing device for a non eligible requestor.

6. The method of claim 1 further comprising:
receiving an authentication request at the at least one processing system, the authentication data request comprising authentication data corresponding to a particular user
comparing the authentication data included in authentication request to stored authentication data for the particular user;
designating the particular user as an authenticated user when the authentication data matches the stored authentication data;
receiving a modification request from the authenticated user, the modification request comprising at least one of updated personal data and update biometric data for the authenticated user; and
storing the at least one of updated personal data and update biometric data in the secure data storage system.

7. The method of claim 6 wherein eligibility data comprises at least one of an educational requirement, a minimum amount of experience, a minimum training time, and a required certification.

8. The method of claim 7 wherein:
the credential generation request further comprises management system data, the manage system identifying the remote computing device; and
the credential data record further comprises the authentication data and the management system data.

9. A system for generating a credential, the system comprising
at least one processor;
at least one data storage system;
an application executed by the at least one processor to:
identify personal data and biometric data included in a credential generation request received at the at least one processor, the credentialing request being associated with a particular requestor and further identifying a desired credential type;
compare the personal data to credential eligibility data stored in the at least one data storage system to verify that the particular requester is eligible for the desired credential type;
store the personal data and biometric data in a credential record in the at least one data storage system for a verified eligible requestor;
retrieve credential generating instructions from the at least one data storage system that correspond to the desired credential type; and
transmit the credential generating instructions to a remote computing device for the verified eligible requestor, wherein the remote computing device is configured to generate a personal identification credential for the verified eligible requestor in accordance with the credential generating instructions.

10. The system of claim 9 wherein the personal identification credential comprises:
visually readable data comprising at least one of a logo, a globally recognized code, a photograph, personal data, and a signature; and
machine-readable data comprising at least one of a radio frequency identification (RFID) chip data, an optical character recognition code, and a bar code.

11. The system of claim 9 wherein biometric data includes a finger print, a signature, a photograph.

12. The system of claim 9 wherein the remote computing device remote device comprises at least one of a personal computer, a laptop computer, and a stand-alone training device.

13. The system of claim 9 wherein the application executed by the at least one processor is further configured to transmit an ineligibility notification to the remote computing device for a non eligible requestor.

14. The system of claim 9 wherein the application executed by the at least one processor is further configured to:
receive an authentication request at the at least one processing system, the authentication data request comprising authentication data corresponding to a particular user
compare the authentication data included in authentication request to stored authentication data for the particular user;
designate the particular user as an authenticated user when the authentication data matches the stored authentication data;
receive a modification request from the authenticated user, the modification request comprising at least one of updated personal data and update biometric data for the authenticated user; and
store the at least one of updated personal data and update biometric data in the secure data storage system.

15. The system of claim 14 wherein eligibility data comprises at least one of an educational requirement, a minimum amount of experience, a minimum training time, and a required certification.

16. The system of claim 15 wherein:
the credential generation request further comprises management system data, the manage system identifying the remote computing device; and
the credential data record further comprises the authentication data and the management system data.

17. A system for generating a credential, the system comprising
at least one processor;
at least one data storage system;
an a comprising modules executable by the at least one processor, the modules comprising:
an eligibility verification module to:
identify personal data and biometric data included in a credential generation request received at the at least one processing system, the credentialing request being associated with a particular requestor and further identifying a desired credential type; and
compare the personal data to credential eligibility data stored in the at least one data storage system to verify that the particular requester is eligible for the desired credential type;
a storage module to store the personal data and biometric data in a credential record in the at least one data storage system for a verified eligible requestor; and
a credential generation module to:
retrieve credential generating instructions from the at least one data storage system that correspond to the desired credential type; and
transmit the credential generating instructions to a remote computing device for the verified eligible requestor, wherein the remote computing device is configured to generate a personal identification credential for the verified eligible requestor in accordance with the credential generating instructions.

18. The system of claim 17 further comprising:
an authentication module to:
receive an authentication request, the authentication data request comprising authentication data corresponding to a particular user;
compare the authentication data included in authentication request to stored authentication data for the particular user; and
designate the particular user as an authenticated user when the authentication data matches the stored authentication data.

19. The system of claim 17 wherein the eligibility verification module is further configured to transmit an ineligibility notification to the remote computing device in response to the credential generation request for a non eligible requestor.

20. The system of claim 17 wherein the personal identification credential comprises:
visually readable data comprising at least one of a logo, a globally recognized code, a photograph, a finger print, and a signature; and
machine-readable data comprising at least one of a radio frequency identification (RFID) chip data, an optical character recognition code, and a bar code.
